(19) United States
(12) Patent Application Publication
(10) Pub. No.: US 2023/0145572 A1
(43) Pub. Date: May 11, 2023

(54) Vehicle Security Assembly

(71) Applicant: Oneal Mills, Gonzales, LA (US)

(72) Inventor: Oneal Mills, Gonzales, LA (US)

(21) Appl. No.: 17/523,347

(22) Filed: Nov. 10, 2021

(51) Int. Cl. B60R 25/30; H04N 7/18; H04N 5/247; H04N 5/77; H04N 5/225; H04N 5/232; H04R 1/02; H04R 1/04; B60R 11/04; B60R 1/12; B60R 25/40

(52) U.S. Cl. CPC B60R 25/30; H04N 7/181; H04N 5/247; H04N 5/77; H04N 5/2252; H04N 5/23241; H04R 1/028; H04R 1/04; B60R 11/04; B60R 1/12; B60R 25/403; H04R 2499/11; B60R 2001/1253

(57) ABSTRACT

A vehicle security assembly includes a vehicle and a plurality of camera units. Each of the camera units is coupled to the vehicle to record video footage of the immediate environment of the vehicle. The plurality of camera unit is positioned at strategic locations on the vehicle. A recording unit is positioned within the vehicle and the recording unit is in electrical communication with each of the camera units to record video footage captured by the camera units. A personal electronic device is positioned within the vehicle. A data sensor is provided which is placed in electrical communication with an engine computer module of the vehicle thereby facilitating the data sensor to receive diagnostic data from the engine computer module. Moreover, the data sensor is in communication with the personal electronic device to facilitate a driver of the vehicle to view the diagnostic data.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to security devices and more particularly pertains to a new security device for recording surveillance footage of an area surrounding a vehicle and to facilitate remote communication between a driver of the vehicle and an individual near the vehicle. The device includes a plurality of camera units, a recording unit, a personal electronic device and a data sensor. The camera units are positioned at strategic locations around the vehicle and the camera units are in communication with the recording unit. The personal electronic device is in communication with the data sensor and the data sensor is in communication with an engine control module of the vehicle to facilitate the driver to monitor fault codes generated by the engine control module.

### (2) Description of Related Art Including Information Disclosed Under 37 CFR 1.97 and 1.98

The prior art relates to security devices including a variety of vehicle surveillance devices that each includes a plurality of digital cameras disposed at various locations on a vehicle. The prior art discloses a variety of vehicle security devices that includes a plurality of video cameras disposed on a vehicle and a personal electronic device that is in remote communication with the video cameras. In no instance does the prior art disclose a security device that includes video cameras, a personal electronic device a data sensor that is in communication with an engine control module of a vehicle.

### BRIEF SUMMARY OF THE INVENTION

An embodiment of the disclosure meets the needs presented above by generally comprising a vehicle and a plurality of camera units. Each of the camera units is coupled to the vehicle to record video footage of the immediate environment of the vehicle. The plurality of camera unit is positioned at strategic locations on the vehicle. A recording unit is positioned within the vehicle and the recording unit is in electrical communication with each of the camera units to record video footage captured by the camera units. A personal electronic device is positioned within the vehicle. A data sensor is provided which is placed in electrical communication with an engine computer module of the vehicle thereby facilitating the data sensor to receive diagnostic data from the engine computer module. Moreover, the data sensor is in communication with the personal electronic device to facilitate a driver of the vehicle to view the diagnostic data.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a vehicle security assembly according to an embodiment of the disclosure.

FIG. 2 is a perspective view of a camera unit of an embodiment of the disclosure.

FIG. 3 is a rear in-use view of an embodiment of the disclosure.

FIG. 4 is an interior view of a vehicle of an embodiment of the disclosure.

FIG. 5 is a phantom in-use view of an embodiment of the disclosure.

FIG. 6 is a schematic view of an embodiment of the disclosure.

### DETAILED DESCRIPTION OF THE INVENTION

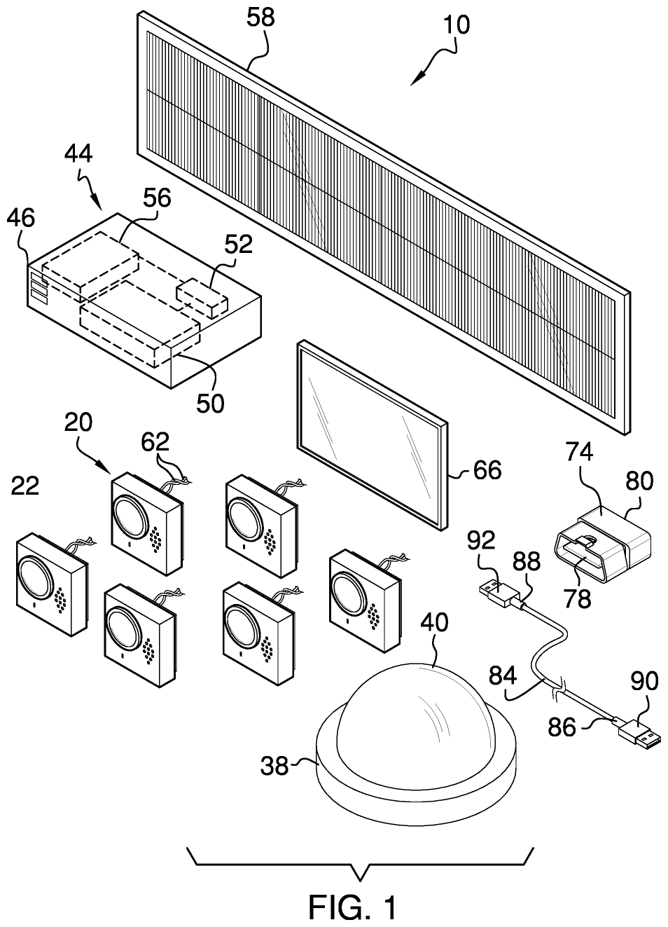

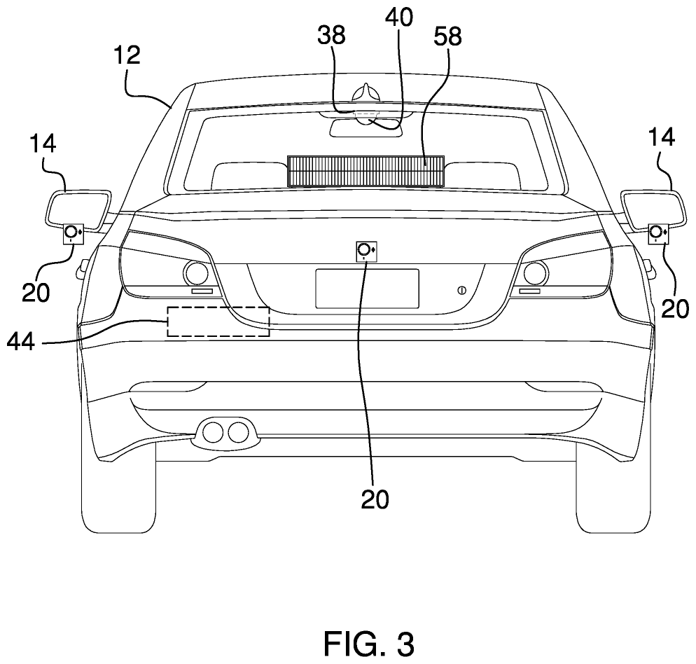

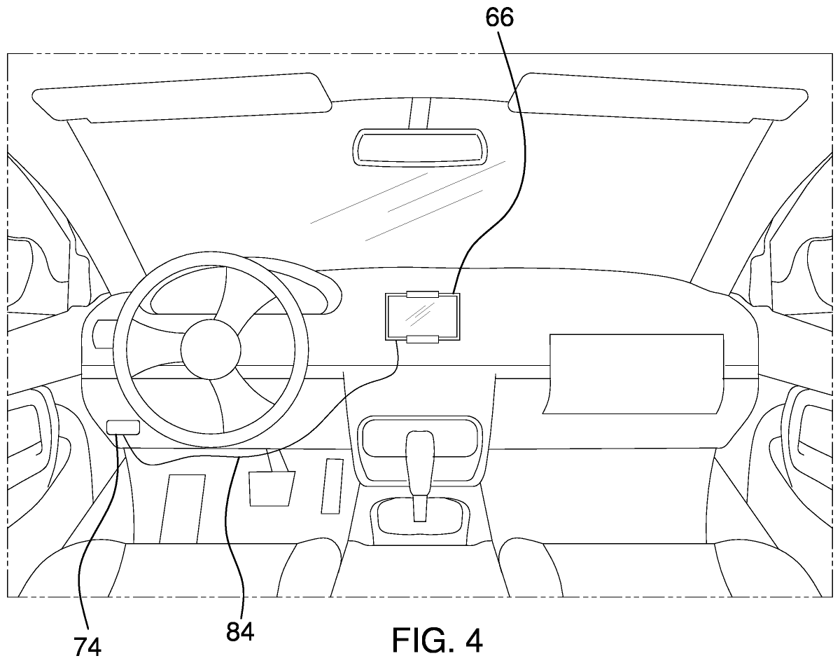

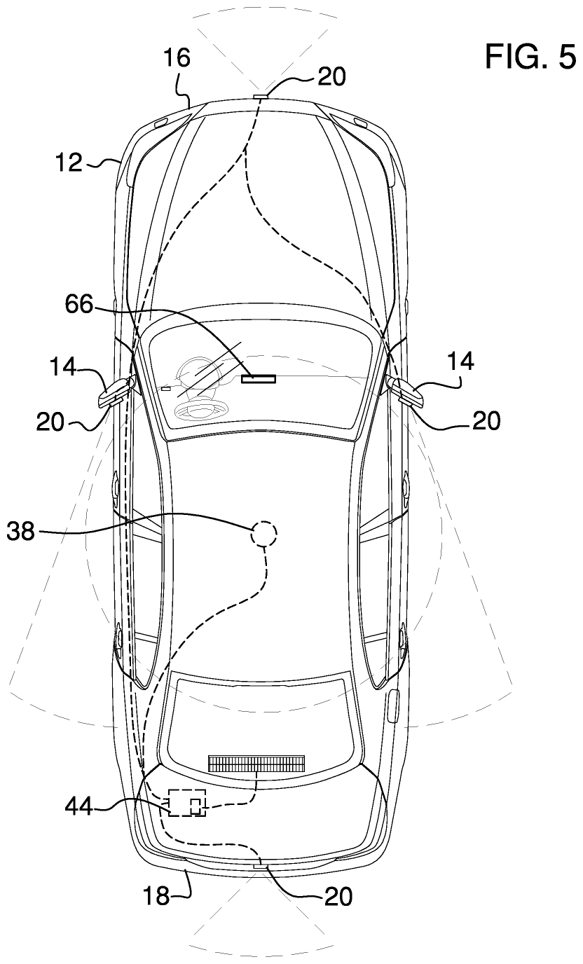

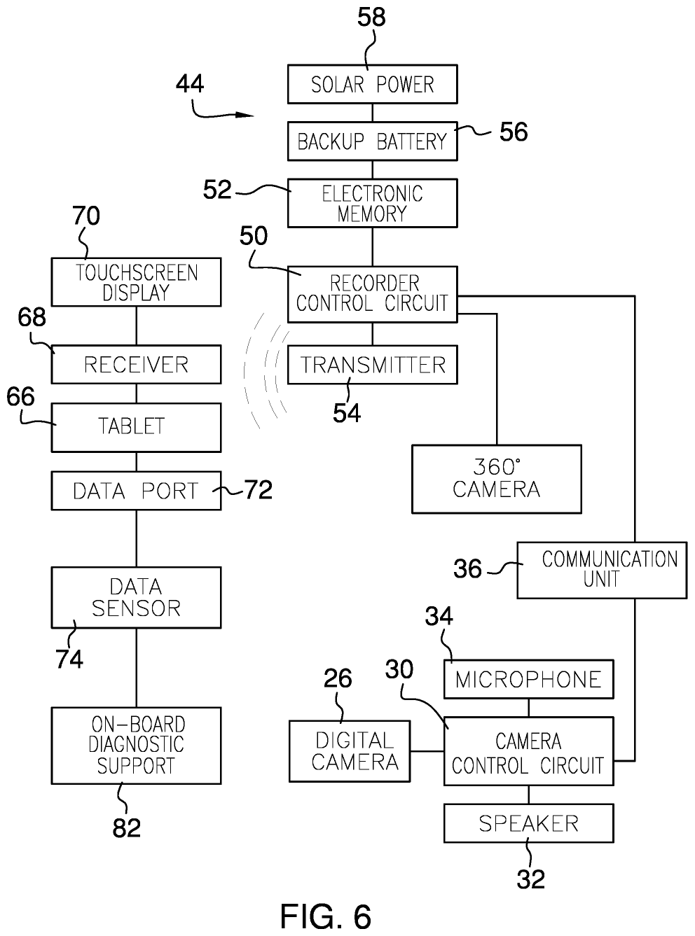

With reference now to the drawings, and in particular to FIGS. 1 through 6 thereof, a new security device embodying the principles and concepts of an embodiment of the disclosure and generally designated by the reference numeral 10 will be described.

As best illustrated in FIGS. 1 through 6, the vehicle security assembly 10 generally comprises a vehicle 12 that has a pair of side mirrors 14, a front end 16 and a back end 18. The vehicle 12 may be a passenger vehicle, a cargo vehicle or any other type of motorized vehicle that is driven on public roadways. A plurality of camera units 20 is provided and each of the camera units 20 is coupled to the vehicle 12 to record video footage of the immediate environment of the vehicle 12. Additionally, the plurality of camera units 20 is positioned at strategic locations on the vehicle 12, including a respective one of the side mirrors 14, the front end 16 of the vehicle 12 and the back end 18 of the vehicle 12. In this way the plurality of camera units 20 can monitor blind spots with respect to a driver of the vehicle 12.

Each of the camera units 20 comprises a camera housing 22 that has a forward wall 24. The camera housing 22 is mounted to the vehicle 12 such that the forward wall 24 is directed in a strategic direction with respect to the vehicle 12. Each of the camera units 20 includes a digital camera 26 that is integrated into the camera housing 22, and the digital camera 26 includes a lens 28 that is integrated into the forward wall 24 to capture imagery related to the direction the forward wall 24 of the camera housing 22 is facing. Each of the camera units 20 includes a camera control circuit 30 that is integrated into the camera housing 22 and the digital camera 26 is electrically coupled to the camera control circuit 30. Moreover the camera control circuit 30 is electrically coupled to a power source 29 comprising an electrical system 31 of the vehicle 12.

Each of the camera units 20 includes a speaker 32 that is integrated into the camera housing 22 to emit audible sounds outwardly from the camera housing 22, and the speaker 32 is electrically coupled to the camera control circuit 30. Each of the camera units 20 includes a microphone 34 that is integrated into the camera housing 22 to capture audible sounds adjacent to the camera housing 22, and the microphone 34 is electrically coupled to the camera control circuit 30. Each of the camera units 20 includes a communication unit 36 that is integrated into the camera housing 22. The communication unit 36 is electrically coupled to the camera control circuit 30 and the communication unit 36 broadcasts a communication signal comprising audio captured by the microphone 34 and video captured by the digital camera 26. The plurality of camera units 20 includes a 360.0 degree camera 38 that includes a fish eye lens 40 to facilitate a 360.0 degree viewing angle. The 360.0 degree camera 38 may be positioned on within the cabin 42 of the vehicle 12 such that the 360.0 degree camera 38 can record video footage of the entirety of the cabin 42 of the vehicle 12.

A recording unit 44 is provided and the recording unit 44 is positioned within the vehicle 12. The recording unit 44 is in electrical communication with each of the camera units 20 thereby facilitating the recording unit 44 to record video footage captured by the camera units 20. The recording unit 44 comprises a recorder housing 46 that is positioned in a trunk 48 of the vehicle 12 such that the recorder housing 46 is secured from unauthorized access. The recording unit 44 includes a recorder control circuit 50 that is integrated into the recorder housing 46 and the recorder control circuit 50 is in electrical communication with the communication unit 36 in each of the camera units 20.

The recording unit 44 includes an electronic memory 52 that is positioned within the recorder housing 46 and the electronic memory 52 is electrically coupled to the recorder control circuit 50. The electronic memory 52 receives video footage captured by the digital camera 26 in each of the camera units 20 and the electronic memory 52 receives audio captured by the microphone 34 in each of the camera units 20.

The recording unit 44 includes a recorder transceiver 54 that is integrated into the recorder housing 46 and the recorder transceiver 54 is electrically coupled to the recorder control circuit 50. The recorder transceiver 54 may comprise a radio frequency transceiver or the like which has an operational range of at least 50.0 feet. The recording unit 44 includes a power supply 56 that is integrated into the recorder housing 46, the power supply 56 is electrically coupled to the recording control circuit and the power supply 56 comprises a rechargeable battery. The power supply 56 is in electrical communication with the communication unit 36 in each of the camera units 20 for supplying back up electrical power to each of the camera units 20 when the electrical system 31 of the vehicle 12 experiences a failure. A solar panel 58 is positionable on the vehicle 12 such that the solar panel 58 is configured to be exposed to sunlight. Furthermore, the solar panel 58 is electrically coupled to the power supply 56 in the recording unit 44 for charging the power supply 56 in the recording unit 44.

As is most clearly shown in FIG. 1, the communication unit 36 in each of the camera units 20 may include a plurality of conductors 60 that are each electrically coupled to the camera control circuit 30 in a respective camera unit 20. Respective ones of the conductors 60 may electrically coupled to the recorder control circuit 50 and respective ones of the conductors 60 may be electrically coupled to the electrical system 31 of the vehicle 12. Additionally, the conductors 60 associated with each of the camera units 20 are routed behind trim panels and structural components of the vehicle 12 such that the conductors 60 are hidden from view.

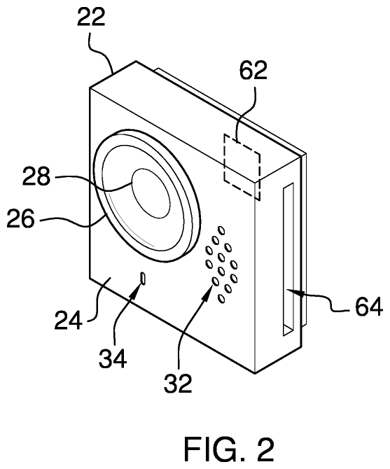

As is most clearly shown in FIG. 2, the communication unit 36 may include a camera transceiver 62 that is electrically coupled to the camera control circuit 30 in a respective camera unit. The camera transceiver 62 may be in wireless communication with the recorder transceiver 54 and the camera transceiver 62 may broadcast the video footage and the audio footage to the recorder transceiver 54. The camera transceiver 62 may comprise a radio frequency transceiver or the like, and each of the camera transceiver 62 and the recorder transceiver 54 may employ Bluetooth communication protocols. As is additionally most clearly shown in FIG. 2, each of the camera units 20 may include a card reader 64 that is recessed into the camera housing 22 which can insertably receive a data card for storing the audio footage and the video footage.

A personal electronic device 66 is provided and the personal electronic device 66 is positioned within the vehicle 12 to be accessible to a driver of the vehicle 12. The personal electronic device 66 includes a receiver 68 and a touch screen display 70. The receiver 68 is in wireless communication with the recorder transceiver 54 in the recording unit 44 such that the personal electronic device 66 is in communication with the speaker 32, the digital camera 26 and the microphone 34 in each of the camera units 20. The personal electronic device 66 has a data port 72 and the personal electronic device 66 may comprise a tablet, a smart phone or any other type of electronic device that has wireless communication capabilities and a touch screen display.

A data sensor 74 is provided which is placed in electrical communication with an engine computer module 76 of the vehicle 12 thereby facilitating the data sensor 74 to receive diagnostic data from the engine computer module 76. The data sensor 74 is in communication with the personal electronic device 66 to facilitate the driver of the vehicle 12 to view the diagnostic data. Moreover, the data sensor 74 has an input port 78 and an output port 80, and the input port 78 is matable to an on-board diagnostic port 82 of the vehicle 12. The data sensor 74 may comprise an electronic on-board diagnostic device that complies with OBD 2 protocols. A data cable 84 is provided that has a first end 86 and a second end 88; a first plug 90 is electrically coupled to the first end 86 and a second plug 92 is electrically coupled to the second end 88. The first plug 90 is matable to the output port 80 on the data sensor 74. The second plug 92 is matable to the data port 72 on the personal electronic device 66.

In use, each of the camera units 20 captures video footage of the immediate area around the vehicle 12 for security purposes. Additionally, the speaker 32 and the microphone 34 in each of the camera units 20 facilitate the driver to remotely communicate with an individual that is near the vehicle 12. The recording unit 44 continually records the video footage and the audio footage captured by each of the camera units 20 for subsequent analysis by law enforcement, or other agency, in the event of theft or vandalism of the vehicle 12. Additionally, the personal electronic device 66 facilitates the driver to view any diagnostic data that is received from the data sensor 74 for monitoring fault codes that are generated by the engine control module 76. Moreover, the driver can monitor the vehicle when service is being performed on the vehicle at a service station, such as a mechanic's shop or a vehicle dealer, thereby facilitating the driver to ensure that service is performed properly. The personal electronic device may be wireless connected to the internet to facilitate video footage captured by the camera devices to be posted to social media sites, for example, or other hosting services on the internet.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle security assembly for capturing video surveillance of the immediate environment of a vehicle, said assembly comprising:
a vehicle having a pair of side mirrors, said vehicle having a front end and a back end;
a plurality of camera units, each of said camera units being coupled to said vehicle wherein each of said camera units is configured to record video footage of the immediate environment of said vehicle, said plurality of camera unit being positioned at strategic locations on said vehicle, each of said camera units being positioned on a respective one of said side mirrors, said front end and said back end;
a recording unit being positioned within said vehicle, said recording unit being in electrical communication with each of said camera units thereby facilitating said recording unit to record video footage captured by said camera units;
a personal electronic device being positioned within said vehicle wherein said personal electronic device is configured to be accessible to a driver of said vehicle, said personal electronic device including a receiver and a touch screen display; and
a data sensor being placed in electrical communication with an engine computer module of said vehicle thereby facilitating said data sensor to receive diagnostic data from said engine computer module, said data sensor being in communication with said personal electronic device wherein said personal electronic device is configured to facilitate the driver of said vehicle to view the diagnostic data.

2. The assembly according to claim 1, wherein each of said camera units comprises:
a camera housing having a forward wall, said camera housing being mounted to said vehicle such that said forward wall is directed in a strategic direction with respect to said vehicle;
a digital camera being integrated into said camera housing, said digital camera including a lens being integrated into said forward wall wherein said lens is configured to capture imagery related to the direction said forward wall of said camera housing is facing;
a camera control circuit being integrated into said camera housing, said digital camera being electrically coupled to said camera control circuit, said camera control circuit being electrically coupled to a power source comprising an electrical system of said vehicle;
a speaker being integrated into said camera housing wherein said speaker is configured to emit audible sounds outwardly from said camera housing, said speaker being electrically coupled to said camera control circuit;
a microphone being integrated into said camera housing wherein said microphone is configured to capture audible sounds adjacent to said camera housing, said microphone being electrically coupled to said camera control circuit; and
a communication unit being integrated into said camera housing, said communication unit being electrically coupled to said camera control circuit, said communication unit broadcasting a communication signal comprising audio captured by said microphone.

3. The assembly according to claim 1, wherein:
each of said camera units includes a digital camera and a microphone; and
said recording unit comprises:
a recorder housing being positioned in a trunk of said vehicle wherein said recorder housing is configured to be secured from unauthorized access;
a recorder control circuit being integrated into said recorder housing, said recorder control circuit being in electrical communication with said communication units in each of said camera units;
an electronic memory being positioned within said recorder housing, said electronic memory being electrically coupled to said recorder control circuit, said electronic memory receiving video footage captured by said digital camera in each of said camera units, said electronic memory receiving audio captured by said microphone in each of said camera units;
a recorder transceiver being integrated into said recorder housing, said recorder transceiver being electrically coupled to said recorder control circuit, and
a power supply being integrated into said recorder housing, said power supply being electrically coupled to said recording control circuit, said power supply being in electrical communication with said communication unit in each of said camera units for supplying back up electrical power to each of said camera units when said electrical system of said vehicle experiences a failure.

4. The assembly according to claim 3, further comprising a solar panel being positionable on said vehicle wherein said solar panel is configured to be exposed to sunlight, said solar panel being electrically coupled to said power supply in said recorder unit for charging said power supply in said recorder unit.

5. The assembly according to claim 3, wherein said receiver being in wireless communication with said transceiver in said recording unit such that said personal electronic device is in communication with said speaker, said digital camera and said microphone in each of said camera units, said personal electronic device having a data port.

6. The assembly according to claim 5, wherein:
said data sensor has an input port and an output port, said input port being matable to an on-board diagnostic port of said vehicle; and
said assembly includes a data cable having a first end and a second end, said first end having a first plug being electrically coupled to said first end, said second end having a second plug being electrically coupled to said second end, said first plug being matable to said output port on said data sensor, said second plug being matable to said data port on said personal electronic device.

7. A vehicle security assembly for capturing video surveillance of the immediate environment of a vehicle, said assembly comprising:
a vehicle having a pair of side mirrors, said vehicle having a front end and a back end;
a plurality of camera units, each of said camera units being coupled to said vehicle wherein each of said camera units is configured to record video footage of the immediate environment of said vehicle, said plurality of camera unit being positioned at strategic locations on said vehicle, each of said camera units being positioned on a respective one of said side mirrors, said front end and said back end, each of said camera units comprising:
a camera housing having a forward wall, said camera housing being mounted to said vehicle such that said forward wall is directed in a strategic direction with respect to said vehicle;
a digital camera being integrated into said camera housing, said digital camera including a lens being integrated into said forward wall wherein said lens is configured to capture imagery related to the direction said forward wall of said camera housing is facing;
a camera control circuit being integrated into said camera housing, said digital camera being electrically coupled to said camera control circuit, said camera control circuit being electrically coupled to a power source comprising an electrical system of said vehicle;
a speaker being integrated into said camera housing wherein said speaker is configured to emit audible sounds outwardly from said camera housing, said speaker being electrically coupled to said camera control circuit;
a microphone being integrated into said camera housing wherein said microphone is configured to capture audible sounds adjacent to said camera housing, said microphone being electrically coupled to said camera control circuit; and
a communication unit being integrated into said camera housing, said communication unit being electrically coupled to said camera control circuit, said communication unit broadcasting a communication signal comprising audio captured by said microphone;
a recording unit being positioned within said vehicle, said recording unit being in electrical communication with each of said camera units thereby facilitating said recording unit to record video footage captured by said camera units, said recording unit comprising:
a recorder housing being positioned in a trunk of said vehicle wherein said recorder housing is configured to be secured from unauthorized access;
a recorder control circuit being integrated into said recorder housing, said recorder control circuit being in electrical communication with said communication units in each of said camera units;
an electronic memory being positioned within said recorder housing, said electronic memory being electrically coupled to said recorder control circuit, said electronic memory receiving video footage captured by said digital camera in each of said camera units, said electronic memory receiving audio captured by said microphone in each of said camera units;
a recorder transceiver being integrated into said recorder housing, said transceiver being electrically coupled to said recorder control circuit, and
a power supply being integrated into said recorder housing, said power supply being electrically coupled to said recording control circuit, said power supply being in electrical communication with said communication unit in each of said camera units for supplying back up electrical power to each of said camera units when said electrical system of said vehicle experiences a failure;
a solar panel being positionable on said vehicle wherein said solar panel is configured to be exposed to sunlight, said solar panel being electrically coupled to said power supply in said recorder unit for charging said power supply in said recorder unit;
a personal electronic device being positioned within said vehicle wherein said personal electronic device is configured to be accessible to a driver of said vehicle, said personal electronic device including a receiver and a touch screen display, said receiver being in wireless communication with said recorder transceiver in said recording unit such that said personal electronic device is in communication with said speaker, said digital camera and said microphone in each of said camera units, said personal electronic device having a data port;
a data sensor being placed in electrical communication with an engine computer module of said vehicle thereby facilitating said data sensor to receive diagnostic data from said engine computer module, said data sensor being in communication with said personal electronic device wherein said personal electronic device is configured to facilitate the driver of said vehicle to view the diagnostic data, said data sensor having an input port and an output port, said input port being matable to an on-board diagnostic port of said vehicle; and
a data cable having a first end and a second end, said first end having a first plug being electrically coupled to said first end, said second end having a second plug being electrically coupled to said second end, said first plug being matable to said output port on said data sensor, said second plug being matable to said data port on said personal electronic device.
